(19) United States
(12) Patent Application Publication
(10) Pub. No.: US 2018/0170489 A1
(43) Pub. Date: Jun. 21, 2018

(54) DEVICES AND METHODS FOR PRODUCING A LARGE-SIZE FLOATING STRUCTURE

(71) Applicant: Richard DZIEWOLSKI, Mougins (FR)

(72) Inventor: Richard DZIEWOLSKI, Mougins (FR)

(21) Appl. No.: 15/578,615

(22) PCT Filed: May 24, 2016
(86) PCT No.: PCT/EP2016/061687

§ 371 Date: Nov. 30, 2017

(30) Foreign Application Priority Data
Jun. 5, 2015 (FR) 1501175

(51) Int. Cl. B63B 35/44; B63B 3/26

(52) U.S. Cl. CPC B63B 35/44; H02S 40/425; B63B 3/26

(57) ABSTRACT

A large-size floating structure which meets the needs for extending the activities of coastal towns is provided. The architectural and technical design can accommodate several thousand inhabitants, while attracting many visitors and customers to live, work and enjoy varied leisure facilities. This energy-autonomous marine district, which is non-polluting and environmentally friendly, constitutes an example of sustainable development. Each component of the structure of the barge provides a maximum of functions: structural, functional, ecological and architectural. By concentrating all of the activities of a town in a single complex, it is easier and more economical to resolve all the problems of sustainable development and safety than in the habitant next to the coast.

### FIELD OF THE INVENTION

The invention relates to the field of large floating structures. More precisely, the invention relates to a floating artificial island that is self-sufficient in energy and is environmentally friendly.

### PRIOR ART

The creation of floating artificial islands in the form of offshore platforms or barges, for tourist infrastructure purposes, presents numerous and varied problems that must be solved, in particular:

choosing shapes and configurations desired by clients, based on market studies ensuring high occupancy;

carrying out studies such that it is possible to solve all the technical problems and justify the feasibility of the concept;

studying the anchoring of the barge which is a precondition for the technical feasibility;

constructing the large floating body , which is difficult in existing shipyards.

Thus, the floating barge must be able to adapt to various types of installation and anchorage, such as:

as a self-contained island installed off the coast and accessible by boat and helicopter (barge anchored by cables and chains in the case of deep water, or resting on jacket piles);

as an island connected to shore by a tunnel and/or a pier (platform on piles).

Each type of anchorage for the floating barge must be the subject of studies taking into account the installation area, in particular the distance to shore, the depth of the sea, the wind, the current, the swell, the tides and the rises in water level.

Furthermore, the floating structure must withstand extreme conditions. In addition, in order to ensure a lifespan of greater than 100 years, the structure of the floating body must be very resistant to corrosion and be very watertight.

Moreover, an artificial island forming a marine city intended for several thousand inhabitants, tourists, visitors and staff must have easy access (pedestrians, cars, boats, helicopters requiring a port for a ferry and pleasure boats and a heliport).

Safety is an important point and the fire safety of the structure must be in accordance with regulations and must permit rapid evacuation (boats—rescue ferry) in the event of an accident or a fire.

It is also necessary for the installations to meet the standards for sustainable development and energy economy. The generation of energy and energy self-sufficiency must be able to be obtained by means of wind turbines, photovoltaic and thermal solar panels, electricity generating units, and/or non-polluting fuel (CO2±=0).

Islands of this kind must be constructed in a manner that respects the environment, with filtration of waste water, production and storage of drinking water, and processing of waste.

In addition, the creation of structures designed to support the photovoltaic and thermal panels, and the glass roof that are to be integrated into the monumental architecture of the marine cities receiving the public, must be the subject of particular studies, including optimization in terms of weight and cost.

Finally, access to the sea must be entirely safe for the inhabitants (floating swimming pools, pleasure boats).

Patent application FR28780865 from CCERET Engineering, by the same inventor Richard Dziewolski as the present application, describes a barge that is designed to form a floating artificial island which, in a preferred application, serves as a fully integrated tourism infrastructure complex installed in a marine site or similar (lake, marsh, etc.).

However, this barge does not fully satisfy the above-described requirements. The present application proposes improvements.

### SUMMARY OF THE INVENTION

The described solution aims to provide improvements to the device presented in the prior art in order to reduce the overall cost of production.

In order to achieve this goal, the present invention proposes various devices and methods with which it is possible to increase the strength of the barge, facilitate the construction of the floating body, allow access to the sea for inhabitants and tourists, make it easier for the installations to conform to standards for sustainable development and energy economy, and propose an anchoring variant for the barge.

Thus, the proposed improvements relate to:

replacing crossbracing with a three-dimensional structure in the form of a cupola supporting solar panels, making it possible to reduce the weight of the steel and simplifying assembly;

a structure supporting the glass roof of the atrium (reference 11 in FIG. 3) that is stronger, supporting a glass roof and a viewing deck;

a novel method for constructing a large floating body with a mixed steel-concrete structure;

protection for the barge from boat impacts and various objects, by means of beaches, pontoons, floating swimming pools that perform several functions;

a device for anchoring the barge by means of cables, completed by means of a novel variant.

Thus, a first object (A1) of the invention is a three-dimensional structure having a canopy of multidirectional trellises in the form of a cupola for the continuous portion. This structure, in a preferred embodiment, is supported by 6 stays attached to the arms of the barge and 48 inclined posts attached to the lower structure, all of which forms a rigid assembly capable of:

increasing the strength of the barge and eliminating the crossbracing provided in the above-mentioned patent;

withstanding forces of extreme wind (250 to 300 km/h);

withstanding the vertical and horizontal reactions of the viewing deck;

supporting the photovoltaic panels for the production of electricity, and thermal panels for heating water;

acting as a sunshade for the glass roof below, providing light to the atrium;

permitting the evacuation of persons on the viewing deck using emergency staircases installed above;

acting as an umbrella, making it possible to collect rainwater for future use; and

simplifying assembly and limiting the cost.

A second object (A2) of the present invention is a three-dimensional structure having a canopy whose geometry provides good resistance to warping of the walls and which is capable of:

supporting the glass roof of a central atrium;

withstanding the vertical and horizontal reactions of a panoramic viewing deck restaurant located at the top of the barge;

ensuring the transverse stability of the central mast which serves as the location for the crane during the assembly phase and which, during the service life phase, supports the weight of a viewing deck, panoramic elevators, emergency staircases and the cable and fluid duct; and simplifying assembly and limiting the cost.

A third object (A3) of the invention relates to a method for constructing a large floating body, larger than 100 m, which is difficult to carry out in existing shipyards. The method is innovative in that the floating body is broken down into multiple elements made of a mixed steel-concrete structure, which are prefabricated in a factory and assembled, floating, at a construction site having a shallow depth of water but ensuring good water-tightness, excellent resistance to corrosion, and making it possible to reduce the weight of steel in comparison to the large steel-built ocean liners. The assembly of these large-span double-curvature three-dimensional structures, composed of small elements (nodes and bars) that are assembled on-site, is particularly complex given the number of different elements of the structure and of the cover, having variable dimensions to be assembled and having to ensure water-tightness.

A fourth object (A4) of the present invention relates to pontoon beaches that form swimming pools and are attached to dams all around the barge. These pontoon beaches are attached by way of articulated joints that control the draft. These pontoon beaches are connected to one another underneath by horizontal nets and on the seaward side by vertical cables and nets. All of this forms bathing zones and serves several purposes:

protection from boat impacts and other diverse floating objects;

acting as a breakwater reducing the nuisance from waves;

protection, for the bathing zones, from drowning, sharks, jellyfish and hydrocarbon pollution.

A fifth object (A5) of the invention relates to an anchoring variant using a device with piles or jacket. This anchoring has the purpose of reducing the movement of the barge when there is a connection to the shore by tunnel and pier. The piles withstand the horizontal and vertical loads resulting from additional increases in weight as a consequence of operation, and climatic loads. The structure to which the present invention relates can adapt to various types of anchoring studied in dependence on the tides and the increases in water level resulting from global warming. It can also be dimensioned to withstand forces due to a tsunami. In this latter case, the sea must be at least 60 m deep and the forces must be defined by tests in a basin. FIG. 8 shows compartments provided in the floating body for housing various connection devices adapted to the manner in which the barge is anchored (with or without draft control).

Thus, the invention relates to a three-dimensional structure comprising a canopy of multidirectional trellises in the form of a cupola, the cupola being supported by a plurality of stays, the structure further comprising a plurality of inclined posts attached to the lower part of the structure, the structure being characterized in that it consists of prefabricated sections, each prefabricated section comprising two curved booms, crosspieces and diagonals.

Advantageously, each stay is a prefabricated section of which the designs consist of the rotation of an arc turning about a vertical axis by a modular angle equal to 360/n.

In one embodiment, the crosspieces are square or rectangular tubes, and the diagonals are round tubes.

Advantageously, the curved booms are obtained by rotation about a vertical axis of an inverted arc obtained by hot-curving of the square tubes.

In one variant embodiment, the structure comprises a network of gutters for rainwater harvesting.

The invention also relates to a barge comprising the three-dimensional structure as described. In one embodiment of the barge, the three-dimensional structure comprises six stays attached to arms of the barge and forty-eight inclined posts, all of this constituting a rigid assembly with which it is possible to increase the strength of the barge.

In one embodiment, the geometry of the canopy of multidirectional trellises makes it possible to support a double-glazed atrium glass roof, wherein this canopy can be included in a barge.

The invention also relates to a large barge having a cupola at the top providing crossbracing and supporting photovoltaic and thermal panels for electricity production and for heating. The cupola forming a composite assembly consists of a tubular three-dimensional structure prefabricated in sections according to the claimed method, a curved steel sheet welded on crosspieces and booms of the structure, L-shaped stiffeners spot-welded to the steel sheet, a frame of predefined geometry based on calculations, lightweight concrete with the addition of a product sealing the concrete filling the metal sheet, the stiffeners and the frame. It also comprises a network of tubes allowing the circulation of a liquid for, on one hand, cooling the photovoltaic panels and the metal structure and thus reduce the thermal expansion of the steel and, on the other hand, heating the water. The cupola has air spaces and panels consisting of safety glazing and adhesively bonded photovoltaic cells for producing electricity.

The barge may comprise means for forming a barge for tourism purposes or a floating artificial island. These means comprise at least:

a large habitable floating body having a mixed steel-concrete structure, said floating body comprising prefabricated elements that are assembled by means of building site joints;

pontoon beaches; and

a system for anchoring the barge in jacket piles, making it possible to reduce the movement of the barge.

Thus, the invention also relates to a barge comprising a large floating body made of a mixed steel-concrete structure, the floating body being made up of prefabricated elements that are assembled while floating, and where each element in direct contact with the seawater has good water-tightness, good resistance to corrosion and a lifespan of 100 years owing to the fact that the walls in direct contact with the seawater are made of steel sheet, stiffeners welded to the steel sheet and cellular crosspieces welded on the steel sheet, thus forming, together, internal formwork ensuring perfect water-tightness of the floating body. The floating body is also made of longitudinal and transverse reinforcement, made of concrete with the addition of a product that seals the concrete. The exterior formwork in direct contact with the seawater may be made either of an imitation rock cladding such as in aquariums or ports, having elements on the external walls that are made of polished concrete with the addition of a resin-based component that avoids spalling of the concrete, such that the assembly contributes to the overall strength and ensures that the walls are sealed and provides protection from corrosion.

In one possible embodiment, the invention is a tourism barge comprising a peripheral protection consisting of pontoon beaches. The pontoon beaches form swimming pools that are attached to dams all around the barge and are connected underneath by horizontal nets and on the seaward side by vertical cables and nets, such that the whole assembly forms bathing zones. These zones can serve several purposes:

protection from boat impacts and other diverse floating objects;

acting as a breakwater reducing the nuisance from waves;

providing monitored bathing zones, to protect from drowning, shark attacks, jellyfish and hydrocarbon pollution.

Advantageously, the pontoon beaches consist of:

cantilevered beaches embedded in the dam;

pontoons designed as a caisson of sealed reinforced concrete (or other materials) comprising ballast compartments for adjusting the draft;

removable stainless steel joints that articulate the pontoons to the cantilevered beaches and that serve for adjusting the draft;

stairs made of reinforced concrete that are attached to the cantilevered beaches supporting the net;

a swimming pool bottom in the form of a net supporting the weight of the bathers and protecting them from drowning, sharks and jellyfish; and

a device for protecting the swimming pools from boat impacts and various floating objects, this device consisting of an upper cable supported by buoy floats, a lower cable suspended from an upper cable and supporting the net, where the net is arranged vertically and is attached to the cables protecting the swimming pool from sharks, jellyfish and hydrocarbon pollution.

The invention also relates to a barge that has an anchoring device which reduces the movement of the barge when subjected to external loads and which is indispensable when the barge is connected to the shore by means of tunnels and piers. The anchoring device is characterized in that the barge is fixed either to piles in bored tubes embedded in the ground and filled with reinforced concrete, or to jackets with the aid of a device that permits horizontal and vertical adjustment, by means of which it is possible to raise and lower the barge, and by means of which it is possible to adjust the draft of the barge as a function of changes in water level.

Advantageously, the floating body of the barge comprises 16 compartments intended for anchoring, four compartments located below six arms that absorb forces concentrated at the ends of the dams.

Advantageously, each compartment comprises a structure by means of which it is possible to assemble the connecting tubes to be attached inside pile tubes providing a connection between the barge and the piles installed below the level of the hull of the barge.

Advantageously, an appropriate raising device makes it possible to raise and lower sleeve tubes and to move them horizontally to align them with the installed position of the piles.

Advantageously, various types of connections with jacket piles can be provided and chosen in dependence on local conditions at the installation side of the platform, as follows:

perfect, non-dismantlable embedding of piles in the structure of the barge: either by welding the sleeves to the piles or by filling the connecting tubes using concrete with additional reinforcing for anchoring, or both together;

embedding the piles in the barge, dismantlable and adjustable, using the device (J) illustrated in FIGS. 17 and 18;

embedding the connecting tube in the piles by welding and concreting and articulation with the tube sliding vertically, providing the connection with the aid of an outside tube embedded by welding and concreting in the anchoring location. This outside tube may have an internal lining of Teflon® facilitating vertical sliding (this solution should be used where there are strong tides and resists only horizontal forces).

The invention also relates to a method for constructing large floating bodies with a mixed steel-concrete structure, involving the steps of:

creating, in a factory, prefabricated elements for the floating body, each element being broken down into multiple prefabricated sections whose dimensions are chosen depending on the type of transport used between the factory and an assembly yard, and where each element that will come into direct contact with seawater is made of a mixed steel-concrete structure; and

assembling the prefabricated elements using building site joints.

### DESCRIPTION OF THE FIGURES

Various aspects and advantages of the invention will appear in support of the description of one preferred, but non-limiting, mode of implementation of the invention, with reference to the figures below:

FIG. 1 shows the structure of the present invention including the improvement devices;

FIG. 2 is a perspective diagram of the cupola of FIG. 1;

FIG. 3 illustrates the principle of prefabrication in sections of beams of the structure of FIG. 1;

FIG. 4 illustrates the principle of using gusset plates to assemble the sections of FIG. 3;

FIG. 5 is a perspective diagram of the structure supporting the glass roof of the atrium;

FIG. 6 shows the principle of prefabricating the structure supporting the glass roof of the atrium;

FIG. 7 shows the details of assembling the structure of FIG. 1;

FIGS. 8a and 8b illustrate the double hull of the floating body of the barge broken down into prefabricated elements;

FIGS. 9, 10 and 11 illustrate the principle of assembling prefabricated elements shown in FIGS. 8a and 8b;

FIGS. 12 to 15 illustrate in various views, sections and perspectives the pontoon features of the present invention;

FIGS. 16, 17 and 18 show the principle of connecting the barge to the jacket piles.

### DETAILED DESCRIPTION OF THE INVENTION

The present invention proposes improving the structure described in the prior art. Therefore, those elements which are shared by the known device will not be described anew, and only the improvement elements are described in more detail.

Thus, the improvements with respect to the subject matter of the above-mentioned French patent are to be found principally in 5 aspects.

However, it must be noted that these devices may find application in fields of construction other than that of floating structures.

A first improvement aspect (A1) relates to the cupola-shaped structure that contributes to the strength of the barge and that supports a canopy. The canopy consists of: stiffened sheet metal, lightweight reinforced concrete, sealing elements, networks of tubes allowing the circulation of water for cooling the metal structure which experiences large expansions and for heating the water (heat pump), and photovoltaic or thermal panels located outside.

A second improvement aspect (A2) is to be found in the three-dimensional structure having a canopy, obtained according to the same construction and assembly method as the cupola-shaped structure, but having a different geometry and supporting a double glazed glass roof of the atrium or another type of covering.

A third improvement aspect (A3) relates to a method for constructing large floating bodies with a mixed steel-concrete structure. This method is innovative in that the floating body is broken down into prefabricated and reassembled elements while allowing each element in direct contact with the seawater to guarantee good water- tightness, good corrosion resistance. Advantageously, this method means that the construction of the structure provides great savings in the use of steel.

A fourth improvement aspect (A4) relates to pontoon beaches, which form swimming pools that are attached to dams all around the barge and are connected underneath by horizontal nets and on the seaward side by vertical cables and nets, such that the whole assembly forms bathing zones, serving several purposes:

protection from boat impacts and other diverse floating objects;

a breakwater reducing the nuisance from waves;

protecting the bathing zones, from drowning, sharks, jellyfish and hydrocarbon pollution.

A fifth improvement aspect A5 relates to the device for anchoring the barge, with which it is possible to reduce the movement of the barge and provide greater security than the known device for anchoring by means of cables. This device is indispensable when the island is connected to the coast by the tunnel and the pier. The anchoring device uses piles or jackets that withstand the forces of the swell, the current and the wind. This device is advantageously suitable for weather conditions in the Mediterranean where the sea is more than 30 m deep, tides do not exceed 50 cm, rise in water level is estimated at ±1.5 m, extreme swell is 6 m and extreme wind is 300 km/h. This device makes it possible to reduce the movement of the barge, which is indispensable when the island is connected to the coast by tunnel and pier.

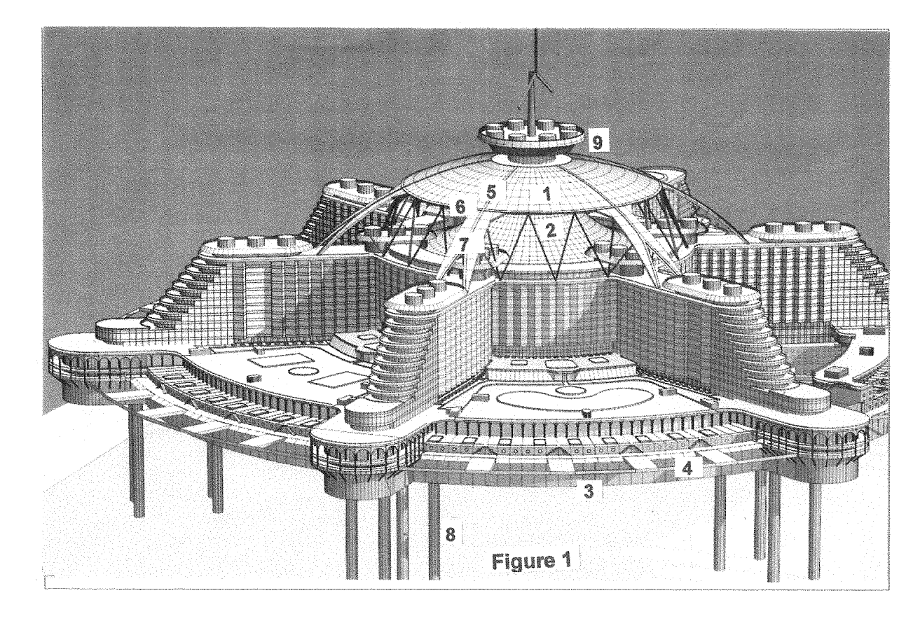

Reference is made to FIG. 1, which shows the structure of the present invention, including the improvement devices. The following are indicated by the references between parentheses:

(1) the cupola

(2) the structure of the atrium

(3) the floating body

(4) the pontoon beaches

(5) the emergency staircases

(6) the gutters and downpipe inside steel tubes supporting the structure for removing rainwater

(7) the stays that transmit the forces from the cupola to the arms

(8) piles by means of which the platform can be anchored, transmitting horizontal and vertical forces

(9) viewing deck and panoramic restaurant.

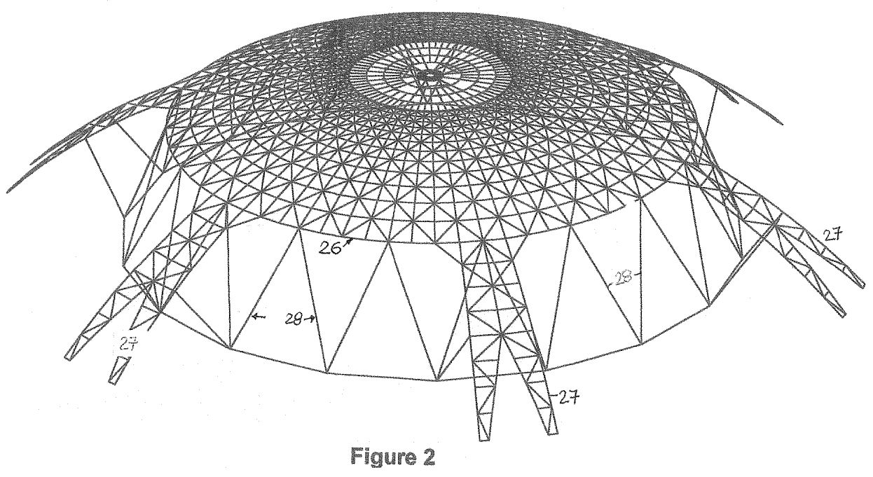

FIG. 2 shows the perspective diagram of the three-dimensional structure with a canopy of multidirectional trellises in the form of a cupola for the continuous part. This structure is supported by 6 stays (27) that are attached to the arms of the barge and 48 inclined posts (28) that are attached to the lower structure forming, with the barge, a rigid assembly that serves previously described functions with reference to the aspect A1.

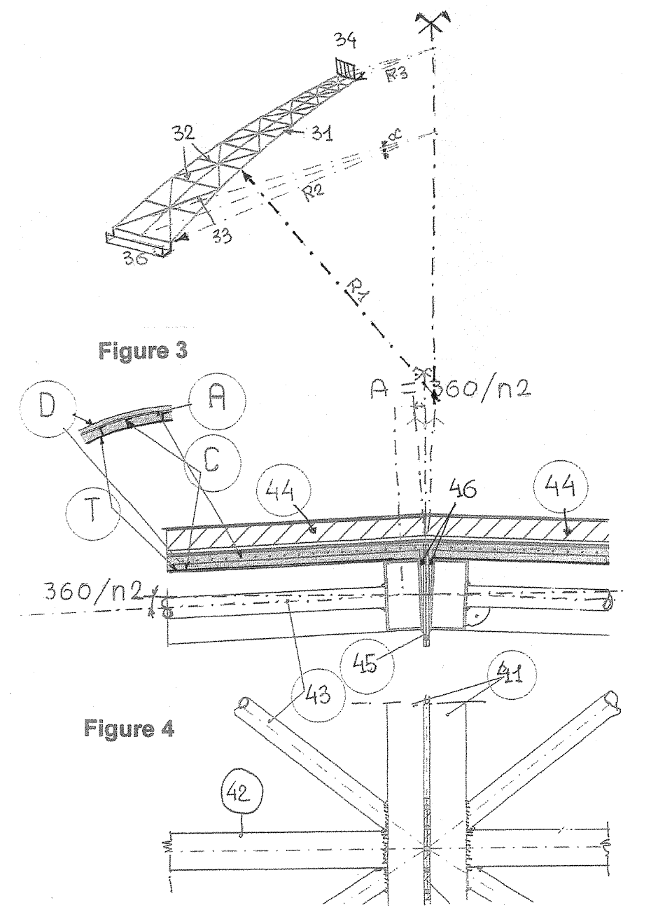

Gutters (26) for rainwater harvesting (for storage, filtration and future use) are provided in the lower portion of the cupola—FIG. 1 (6)—FIG. 2 (26)—FIG. 3 (36)—and the downpipes within the posts in tubes (28) and the posts of 6 stays (27). The structure is prefabricated in “sections” of which the designs consist of the rotation of an arc turning about a vertical axis by a modular angle=360/n.

FIG. 3 shows the principle of modelling the designs of the structure where R1 is the radius of curvature of the arc, R2 is the radius of the lower portion of the cupola, R3 is the radius of the upper portion supporting the viewing deck (34). Each section consists of 2 curved booms—FIG. 3 (31) FIG. 4 (43)—of the crosspieces—FIG. 3 (32) and FIG. 4 (42)—in square or rectangular tubes and diagonals and round tubes—FIG. 3 (33) and FIG. 4 (43). The curved trellis beams forming “the sections” shown in FIGS. 3 and 4 are assembled on-site either by welding or by bolting using the gusset plates (45) of FIG. 4 comprising welded adjustment shims (46).

The structure of the cupola supports photovoltaic and thermal panels in the form of sandwich panels (44) consisting of:

curved stainless steel sheet (T) welded on crosspieces and booms of the main structure;

L-shaped stiffeners (C) spot-welded to the steel sheet;

reinforcement (A) defined by calculation;

lightweight concrete (D) with the addition of a product that seals the concrete; insulation+sealing (as required);

networks of tubes allowing the circulation of a water (like that for underfloor heating) in order, on one hand, to cool the photovoltaic panels and the metal structure and, on the other hand, to heat water (sanitary hot water, heating, heat pump);

air void;

photovoltaic or thermal panels and small-scale wind turbines.

Advantageously, this device makes it possible:

to make the roof watertight;

to thermally insulate the metal structure experiencing large differences in temperature;

to reduce the noise from the wind turbines attached above;

to produce electricity;

to heat water and to cool the photovoltaic panels and the metal structure that is heated by the sun and by the photovoltaic and thermal panels (reducing the thermal expansion of the metal structure);

to simplify and reduce the cost of assembling the cupola.

Advantageously, the cupola designed according to the method of the invention may be used as a cover for various types of building: sporting buildings, stayed here, hotels, factories, etc. For large spans, the structure of the cupola may comprise a lower canopy that increases strength and reduces the deformations of the latter.

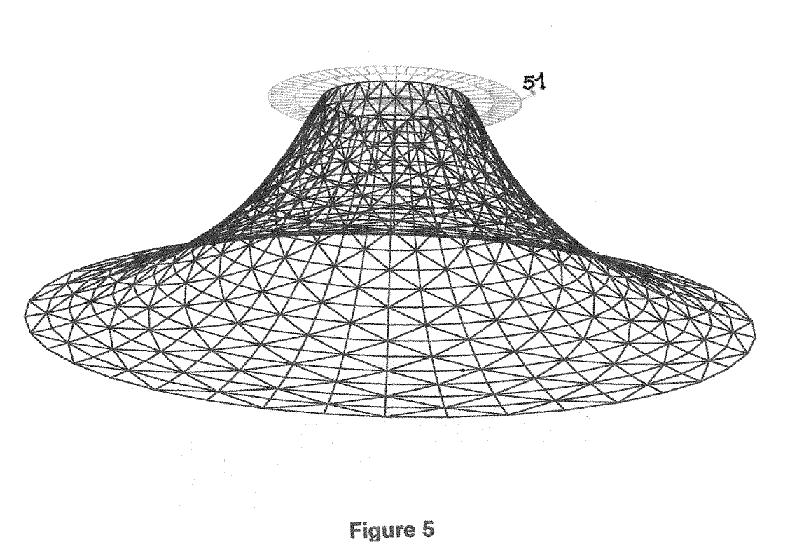

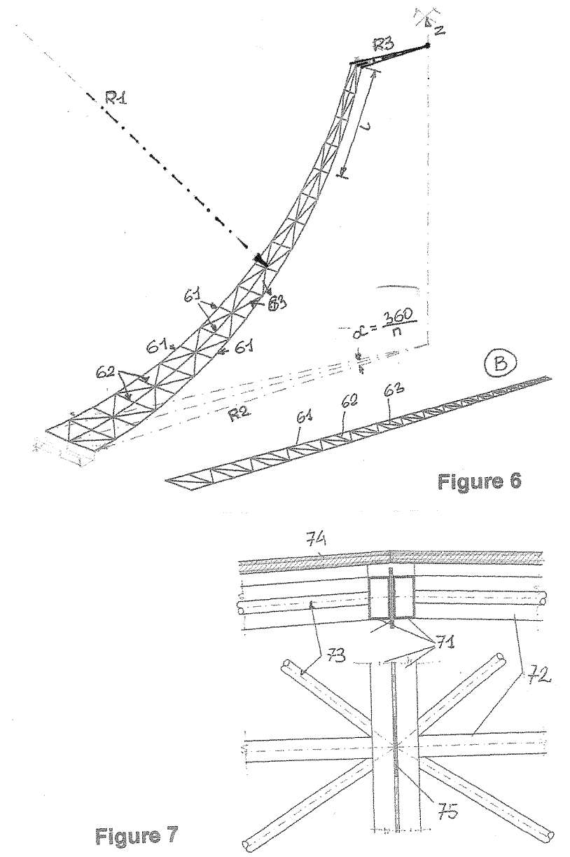

FIG. 5 shows a perspective diagram and the details for assembling the structure supporting the glass roof of the atrium (double glazing (74) of FIG. 7) and the viewing deck ((9) FIGS. 1 and (51) FIG. 5). This structure is created and assembled as the structure shown in FIG. 4 and described above. FIG. 6 shows the principle of prefabricating the structure supporting the glass roof of the atrium. It is broken down into elements that are prefabricated and are assembled on-site as per the details of FIG. 7. The geometry of the designs of the structure is obtained by rotation about a vertical axis (modular angle=360/n) of an inverted arc (radius of curvature=R1, radius of the atrium=R2, radius of the upper opening=R3 according to the detail of FIG. 6).

The elementary sections forming the structure consist of: booms (61) FIGS. 6 and (71) FIG. 7, made of square or rectangular tubes, crosspieces (62) FIGS. 6 and (72) FIG. 7, and diagonals (63) FIGS. 6 and (73) FIG. 7, made of square, rectangular or round tubes. These sections which are flat when welded (detail B of FIG. 6) are hot-curved in the factory. The diagonals and the crosspieces are welded to the curved booms (bias-cut of the crosspieces and the diagonals with angles=360/2n). The elements in the form of sections are broken down into segments (I) FIG. 6 of which the length is dependent on the means of transport between the factory and the construction site.

FIG. 7 shows the details of assembling two sections of the structure (plan view and section view), comprising:

booms (71) made of square or rectangular tubes,

crosspieces (72) and diagonals (73) made of square, rectangular or round tubes,

a transverse assembly of the sections of the structure by welding or by means of bolts using gusset plates (75),

double glazing (74) comprising an aluminium frame attached to the crosspieces (72) and the curved booms (71).

Advantageously, the glass roof may be replaced with roofing panels or a covering for other applications such as for the cooling towers of nuclear power plants, for example.

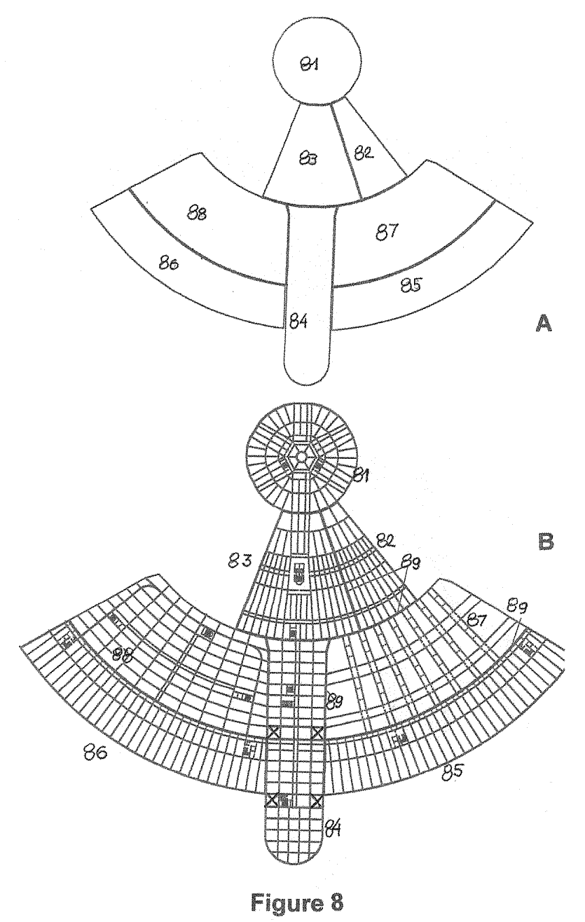

FIG. 8 shows the double hull of the floating body of the barge broken down into prefabricated elements shown in part (A), and assembled in a collaborating steel formwork shown in part (B). The dimensions of the prefabricated elements (81 to 88) are defined in dependence on the capabilities of the construction yards producing these elements.

The metal structure of each element may be broken down into several segments created in different factories. The yard producing the elements is tasked with assembling the metal segments by welding, with putting in place the reinforcement and with concreting the sole, the flanges and the bridge 2 that constitute the double hull that is then launched and towed to the site for assembling the floating body (a construction yard having sufficient depth of water).

FIG. 8 shows the various elements of the structure having references 81 to 88:

1 central element (81) of the central floating body

6 elements (82) of the central floating body

6 elements (83) of the central floating body

6 elements of the floating body arm (84)

3 dam elements (85)

3 dam elements (86)

2 SPA elements (87)

4 port bottom elements (88).

The 4 compartments of the floating bodies (84) indicate the zones for anchoring the barge, either using chains and cables or using connections to jacket piles. This device is described in detail in improvement (A5).

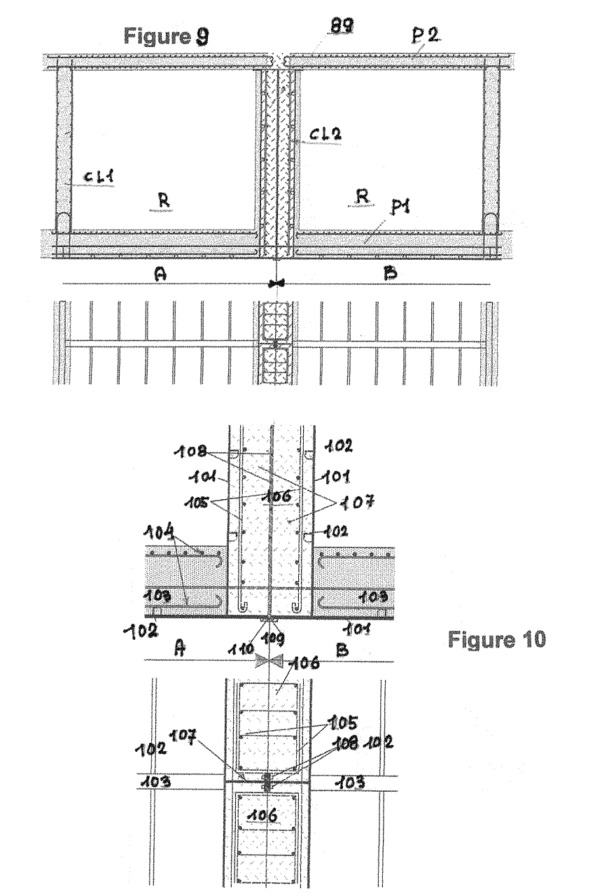

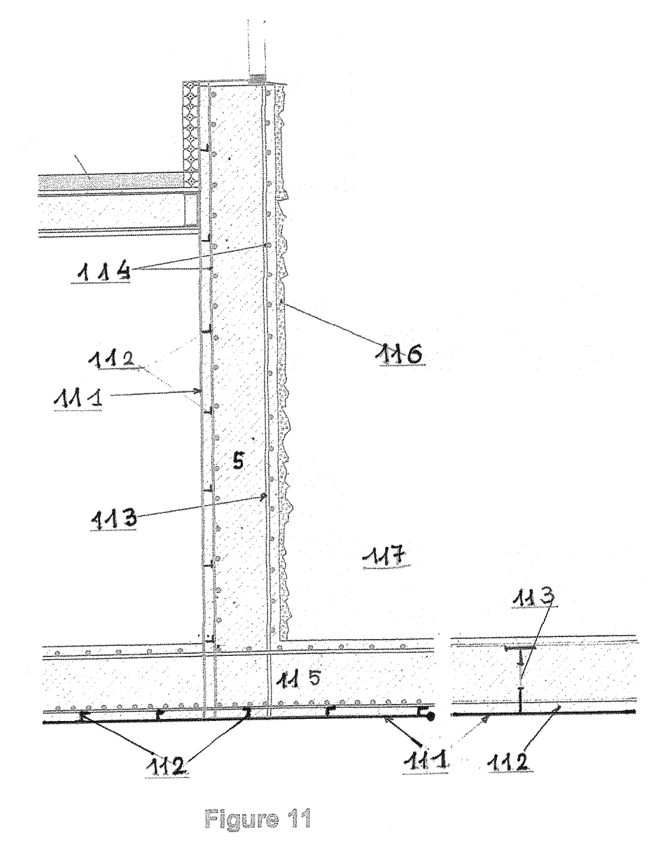

The prefabricated elements defined hereinabove are assembled using construction site joints shown in FIG. 8 and FIG. 9, with references (89, 99). Each element in direct contact with seawater (the skins and the intermediate flanges delimiting the prefabricated and towed elements) is produced according to the principle plan of FIGS. 9, 10 and 11. Each element consists of:

(101) steel sheet;

(102) stiffeners welded to the steel sheet;

(103) cellular crosspieces welded on the steel sheet, these 3 latter forming the collaborating formwork that guarantees perfect water-tightness of the floating body;

(104) longitudinal and transverse reinforcement;

(105) concrete with the addition of a product that seals the concrete;

(106) coating imitating the rocks in aquariums in the form of lost formwork or in the port elements of polished concrete that contribute to strength and seal the walls;

(107) aquarium.

FIGS. 9, 10 and 11 illustrate the principle of assembling prefabricated elements shown in FIGS. 8a and 8b. They also provide the details of the composition of the walls made of a mixed steel-concrete structure delimiting those elements which are in direct contact with seawater.

FIGS. 9 and 10 show more specifically the whole of the floating body sole bridge 1 (P1) made of a mixed structure described hereinabove which is connected to the bridge 2 (P2) with the aid of partitions (CL1) and (CL2)—flange beams providing strength (and forming the double hull) and delimiting the ballasts and the reservoirs (R). Assembly of the prefabricated elements, after adjustment of the drafts (by means of the additional dead weight, by ballasting or by means of actuators) is carried out according to the detail of FIGS. 9 and 10 in the following order:

assembly of the butt ends of the T-shaped uprights (107) by means of bolts HR (108) (the working region is previously isolated from the rest) and butt welding (109) of the sheet metal (101) with the aid of the adjusting plate (1010);

installation of the complementary reinforcement (105); and

concreting of the space using watertight concrete (106).

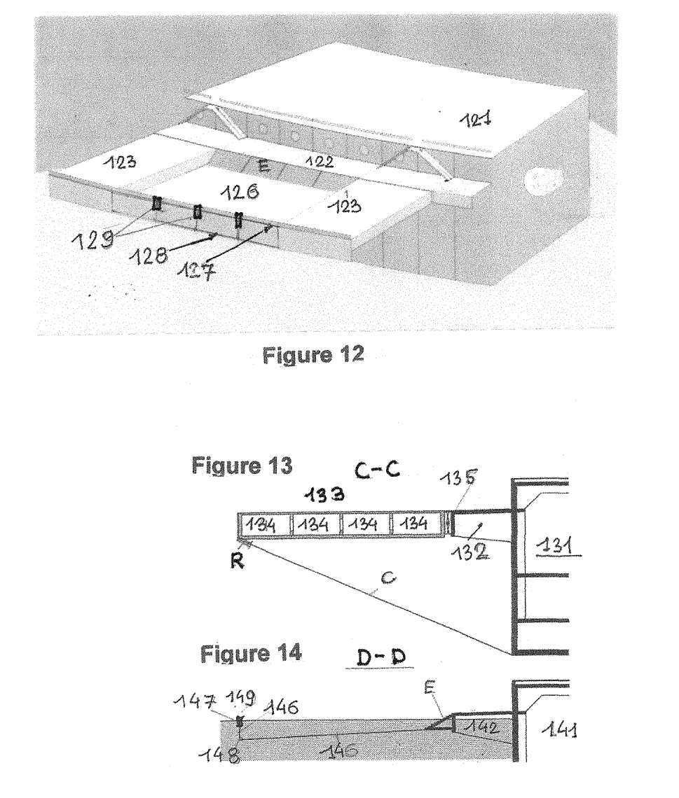

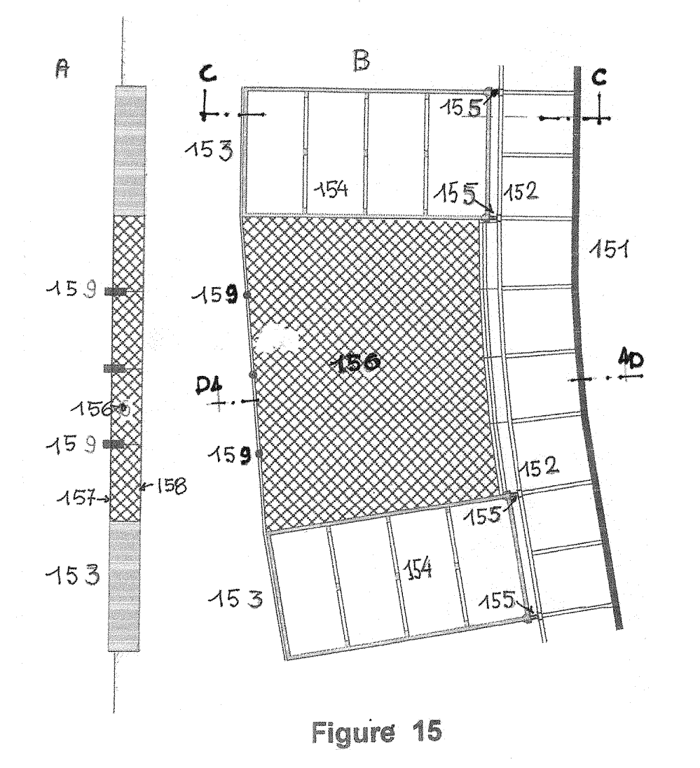

Advantageously, the pontoon beaches, forming swimming pools, are shown in FIGS. 12, 13, 14 and 15, which represent views in perspective, sections and a plan view. The pontoon beaches consist of:

(121, 131, 141, 151) a floating dam protecting the port;

(122, 132, 142, 152) cantilevered beaches embedded in the dam;

(123, 133, 143, 153) pontoons made as a caisson of watertight reinforced concrete (or other materials) comprising ballasting compartments (134) for adjusting the draft and possibly the cables (C) with a device for adjusting the tension (R) (reduction of the vertical movements of the pontoon) connecting the ends of the pontoon to the base of the floating body;

(135, 155) removable stainless steel joints that articulate the pontoons to the cantilevered beaches and that serve for adjusting the draft;

(E) in FIG. 12: staircases made of reinforced concrete, attached to the cantilevered beaches supporting the net (126, 146, 156);

a swimming pool bottom in the form of a net (126, 146, 156) supporting the weight of the bathers and protecting them from drowning, sharks and jellyfish;

(P) of FIGS. 13 to 15: a device for protecting the swimming pools from boat impacts and various floating objects, this device consisting of:

(157) an upper cable supported by buoy floats (159);

(158) a lower cable suspended from an upper cable and supporting the net (156);

the net is arranged vertically and is attached to the cables protecting the swimming pool from sharks, jellyfish and hydrocarbon pollution.

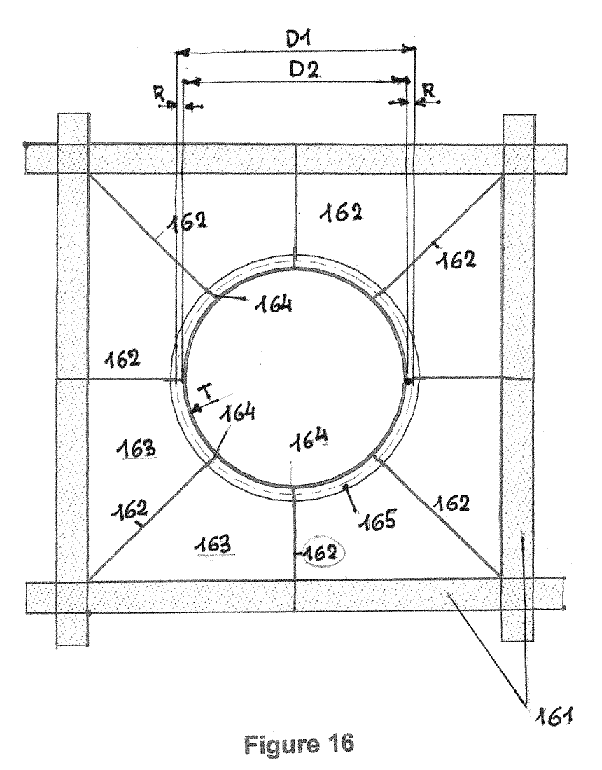

A fifth improvement aspect (A5) relates to the anchoring variant replacing the cables and chains with a device of piles or jackets embedded in the sea floor. FIGS. 16, 17 and 18 provide the details of the proposed anchoring device. Advantageously, the floating body of the barge, shown in FIG. 8, comprises 16 compartments (X) intended for anchoring, that is to say four compartments located below six arms (84) that absorb forces concentrated at the ends of the dams (85) and (86). Advantageously, each compartment, shown in FIG. 16, comprises a structure by means of which it is possible to assemble the connecting tubes to be attached inside pile tubes providing a connection between the barge and the piles installed below the level of the hull of the barge. Advantageously, an appropriate raising device makes it possible to raise and lower the sleeve tubes and to move them horizontally to align them with the installed position of the piles (adjustment (R) in FIG. 18). Advantageously, various types of connections with jacket piles can be provided and chosen in dependence on local conditions at the installation side of the platform, as follows:

perfect, non-dismantlable embedding of piles in the structure of the barge: either by welding the sleeves to the piles or by filling the connecting tubes using concrete with additional reinforcing for anchoring, or both together. This device makes it possible to absorb vertical and horizontal forces (swell+wind+rising water level). This simplest solution can be suitable for the Mediterranean Sea for a lifespan of the barge of 100 years;

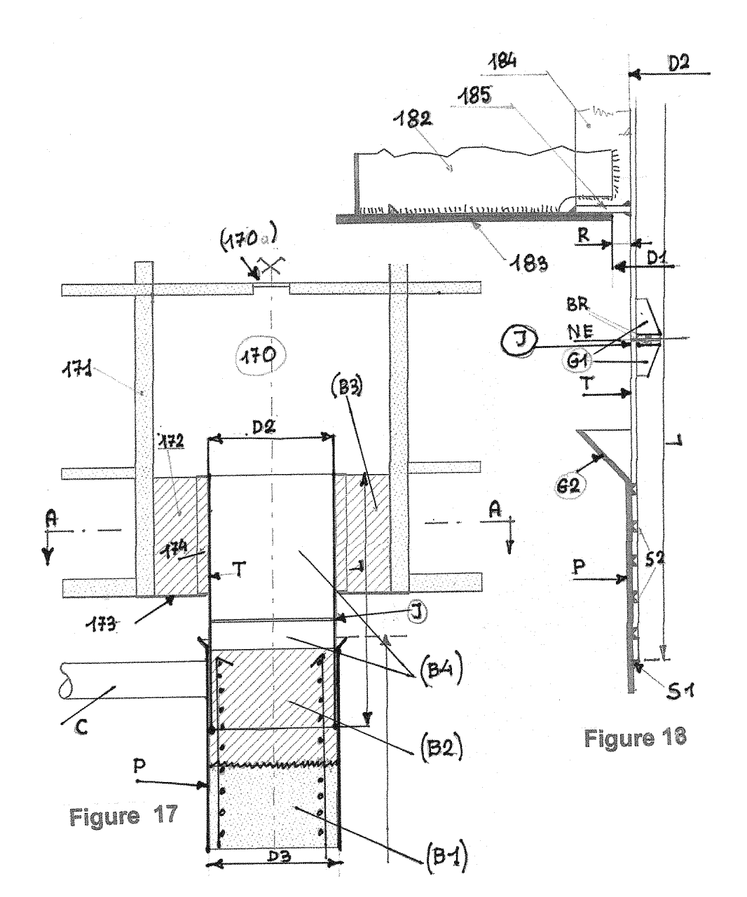

embedding the piles in the barge, dismantlable and adjustable, using the device (J) shown in FIGS. 17 and 18;

embedding the connecting tube in the piles by welding and concreting and articulation with the tube sliding vertically, providing the connection with the aid of an outside tube embedded by welding and concreting in the anchoring location (X). This outside tube may have an internal lining of Teflon facilitating vertical sliding (this solution should be used where there are strong tides and resists only horizontal forces).

FIG. 16 shows the anchoring location in horizontal section A-A of FIG. 17, with the details of the connection between the barge and the jacket piles. The following references apply:

(161) double walls of steel filled with reinforced concrete

(162) steel flanges welded to the walls and the sheet metal of the sole (163)

(164) vertical stiffener welded to the connecting tube (T) and to the flange (162) after adjustment (R) of the verticality (tolerance of installation of the jacket piles)

(165) collar welded to the tube and to the sheet metal (163) after adjustment (the opening in the sheet metal (D1) that is larger than the diameter of the tube (T) makes it possible to accommodate any lack of precision incurred in installation of the jacket piles. The booms of the piles made of steel tubes are filled with the reinforced concrete and are embedded in the ground by boring (in the manner of a dolphin).

FIGS. 17 and 18 show the details of the assembly of the tube connecting the barge to the jacket pile, in vertical section with the details. The following references apply:

(170) pressurized anchoring area in order to expel water

(170 a) technical area entry airlock with watertight hatch

(171) double wall of steel filled with the reinforced concrete encircling the anchoring area

(173 and 183) steel sheet reinforced with the stiffeners forming the sole of the anchoring area

(172 and 182) gusset plate—flange welded to the stiffeners of the tube after adjustment (R) of the alignment

(174 and 184) vertical stiffener welded to the tube (T)

(185) sheet metal collar welded to the tube (T) and to the sheet metal (173 and 183) after alignment adjustment

(T) steel tube of outer diameter D2 matched to the inner diameter of the pile (P)

(E) thickness of the walls of the tube

(J) connecting tube (T) seal making it possible to disconnect the barge and modify the draft of the barge in the event of a rise in water level by adding a complementary part (alternative solution)

(BR) 2 collars welded to 2 segments of the tube reinforced by gusset plates (G1) welded to the collars and the tubes

(NE) neoprene seal

(HR) bolts for clamping and for transmitting horizontal forces

(L) length of the connecting tube

(P) pile made of steel tubes filled with the concrete (dolphin forming part of the jacket embedded in the ground)

(C) crossbracing of the jacket (crosspieces+diagonals forming, with the pile, a rigid structure)

(G2) gusset—funnel facilitating the alignment of the tube axes during installation

(S1) angle welding of the connecting tube with the walls of the jacket pile

(S2) plug welding

(B1) end of concreting of piles

(F) reinforcing of the piles

(B2) concreting after completion of the welded joints (S1) and (S2)

(B3) concreting of compartments of the anchoring area

(B4) possible concreting inside the connecting tube for non-dismantlable embedding subject to verification of the strength of the structure when subjected to a rise in water level.

Thus, a person skilled in the art will appreciate that the structure meets the requirements of extending the activities of coastal cities suffering from lack of space as a consequence of sea level rise produced by global warming which will, in the near future, cause flooding of areas located close to the sea.

The architectural and technical concept deriving from the present invention makes it possible to house several thousand inhabitants while attracting numerous visitors and clients for living, working and taking advantage of the varied leisure provisions. Such a marine city, which is self-sufficient in terms of energy, is non- polluting and respectful of the environment, represents an innovative example of sustainable development.

Each component of the structure of the barge performs a number of functions: structural, functional, ecological and architectural.

By concentrating all of the activities of a city in a single complex, all of the problems of sustainable development and security can be solved more easily and more economically than in the coastal habitat. The novel barge-platform, designed in accordance with the method of the invention, may be anchored offshore where depths exceed 50 meters, and by virtue of its structure is more resistant to tsunamis than constructions built on the coast.

Thus, the novel structure advantageously makes it possible to abide by the expected objectives, according to a method of construction of prefabricated elements that simplifies assembly, reduces weight and limits the cost of the barge. The proposed method covers, in particular:

the construction of double curvature structures, used for the cupola supporting the solar panels and for the structure supporting the glass roof of the atrium;

the construction of a large floating body, greater than 100 m, broken down into multiple elements made of a mixed steel-concrete structure, prefabricated in a factory and assembled while floating, at a construction site having a shallow depth of water but ensuring good water-tightness and excellent resistance to corrosion;

the construction of pontoon beaches, which form swimming pools that are attached to dams all around the barge, forming bathing zones serving purposes of protection from boat impacts and other floating objects, a breakwater reducing the nuisance from waves, protecting the bathing zones from drowning, from sharks, from jellyfish and from hydrocarbon pollution.

The novel structure also covers a device for anchoring the barge in the jacket piles, making it possible to reduce the movement of the barge in the case where there is a connection with the coast by tunnel and pier.

1. A large barge having a cupola at the top providing crossbracing and supporting photovoltaic and thermal panels for electricity production and for heating, the cupola forming a composite assembly comprising:
a tubular three-dimensional structure prefabricated in sections;
a curved steel sheet welded on crosspieces and booms of the structure;
L-shaped stiffeners spot-welded to the steel sheet;
a frame of predefined geometry;
lightweight concrete with the addition of a product sealing the concrete filling the metal sheet, the stiffeners and the frame;
the cupola further comprising:
a network of tubes allowing the circulation of a liquid for cooling the photovoltaic panels and the three-dimensional structure and heating the water;
air spaces; and
panels comprising safety glazing and adhesively bonded photovoltaic cells for producing electricity.

2. The barge as claimed in claim 1, wherein the three-dimensional structure comprises a canopy of multidirectional trellises in the form of a cupola, the cupola being supported by a plurality of stays, the structure further comprising a plurality of inclined posts attached to the lower part of the structure, the structure comprising prefabricated sections, each prefabricated section comprising two curved booms, crosspieces and diagonals.

3. The barge as claimed in claim 2, wherein each stay is a prefabricated section of which the designs consist of the rotation of an arc turning about a vertical axis by a modular angle equal to 360/n.

4. The barge as claimed in claim 2, wherein the crosspieces are square or rectangular tubes, and the diagonals are round tubes.

5. The barge as claimed in claim 1, wherein the curved booms are obtained by rotation about a vertical axis of an inverted arc obtained by hot-curving of the square tubes.

6. The barge as claimed in claim 1, further comprising a network of gutters for rainwater harvesting.

7. The barge as claimed in claim 1, wherein the geometry of the three-dimensional structure makes it possible to support a double-glazed atrium glass roof.

8. The barge as claimed in claim 7, wherein the three-dimensional structure comprises six stays attached to arms of the barge and forty-eight inclined posts, all of this constituting a rigid assembly with which it is possible to increase the strength of the barge.

9. The barge as claimed in claim 8, further comprising means to form a barge for tourism purposes.

10. The barge as claimed in claim 9, wherein the means comprise at least:
a large habitable floating body having a mixed steel-concrete structure, said floating body comprising prefabricated elements that are assembled by means of building site joints;
beach pontoons; and
a system for anchoring the barge in jacket piles, making it possible to reduce the movement of the barge.

11. The barge as claimed in claim 9, further comprising peripheral protection comprising pontoon beaches forming swimming pools that are attached to dams all around the barge and are connected underneath by horizontal nets and on the seaward side by vertical cables and nets, such that the whole assembly forms bathing zones.

12. The barge as claimed in claim 11, wherein the pontoon beaches comprise:
cantilevered beaches embedded in the dam;
pontoons designed as a caisson of sealed reinforced concrete (or other materials) comprising ballast compartments for adjusting the draft;
removable stainless steel joints that articulate the pontoons to the cantilevered beaches and that serve for adjusting the draft;
stairs made of reinforced concrete that are attached to the cantilevered beaches supporting the net;
a swimming pool bottom in the form of a net supporting the weight of the bathers and protecting them from drowning, sharks and jellyfish; and
a device for protecting the swimming pools from boat impacts and various floating objects, this device comprising an upper cable supported by buoy floats, a lower cable suspended from an upper cable and supporting the net, where the net is arranged vertically and is attached to the cables protecting the swimming pool from sharks, jellyfish and hydrocarbon pollution.

13. The barge as claimed in claim 1, comprising an anchoring device which serves to reduce the movement of the barge when subjected to external loads, the anchoring device wherein the barge is fixed either to piles in bored tubes embedded in the ground and filled with reinforced concrete, or to jackets with the aid of a device that permits horizontal and vertical adjustment, by means of which it is possible to raise and lower the barge, and by means of which it is possible to adjust the draft of the barge as a function of changes in water level.

14. The barge as claimed in claim 13, wherein the barge comprises a large habitable floating body comprising sixteen compartments designed for anchoring, for compartments being located below six arms that take up the forces that concentrate at the ends of the dams.

15. The barge as claimed in claim 14, wherein each compartment comprises a structure by means of which it is possible to assemble connecting tubes to be attached inside pile tubes providing a connection between the barge and the piles installed below the level of the hull of the barge.

16. The barge as claimed in claim 13, wherein the raising device makes it possible to raise and lower sleeve tubes and to move them horizontally to align them with the installed position of the piles.

17. A method for constructing a barge as claimed in claim 1, comprising steps of constructing a large floating body with a mixed steel-concrete structure, comprising:
creating, in a factory, prefabricated elements for the floating body, each element being broken down into multiple prefabricated sections whose dimensions are chosen depending on the type of transport used between the factory and an assembly yard, and where each prefabricated element that will come into direct contact with seawater is made of a mixed steel-concrete structure; and
assembling the prefabricated elements using building site joints.
